(19) United States
(12) Patent Application Publication
(10) Pub. No.: US 2017/0166078 A1
(43) Pub. Date: Jun. 15, 2017

(54) BATTERY CHARGE EQUALIZATION SYSTEM

(71) Applicant: Ford Global Technologies, LLC, Dearborn, MI (US)

(72) Inventors: Larry Dean Elie, Ypsilanti, MI (US); Alexander David Colvin, Oak Park, MI (US)

(21) Appl. No.: 14/966,786

(22) Filed: Dec. 11, 2015

(51) Int. Cl. B60L 11/18

(52) U.S. Cl. CPC B60L 11/1866; B60L 11/1861; H02J 7/345

(57) ABSTRACT

A vehicle having a traction battery power source includes n power cells each having a positive and negative terminal and connected in series to form a power pack, and n−1 comparators configured as voltage followers. A negative terminal of a m^{th} comparator of the n−1 comparators is connected to the negative terminal of a corresponding m^{th} cell of the n cells. And, a positive terminal of the m^{th} comparator is connected to the positive terminal of a (m+1)^{th} cell of the n cells.

### TECHNICAL FIELD

This application generally relates to energy management for hybrid vehicles.

### BACKGROUND

Many power packs such as a battery pack have an operating voltage greater than a voltage of a single cell of the power pack. For example, a voltage of a traction battery pack for a hybrid-electric vehicle may be 200-300 Volts DC while a voltage of a single battery cell may be 1-4 Volts DC. The 1-4V DC range for a single battery cell typically is associated with the technology of the battery cell. For example, a Nickel Metal Hydride (NiMH) battery cell typically has a cell voltage of approximately 1.2 Volts and a Lithium Ion (Li-Ion) battery cell typically has a cell voltage of approximately 3.6 Volts. A hybrid-electric vehicle traction battery provides power for vehicle propulsion and accessories. To meet the voltage and current requirements, the traction battery is typically multiple battery cells connected in a combination of series and parallel. During vehicle operation, the traction battery may be charged or discharged based on operating conditions including a battery state of charge (SOC), internal combustion engine (ICE) operation, driver demand and regenerative braking. A state of charge of individual battery cells within a battery pack may be unequal based on many factors including variations in manufacturing, cell age, cell temperature, or cell technology. Battery cell balancing may be used to re-balance individual battery cell's state of charge within the battery pack and improve operation of the battery pack.

### SUMMARY

A battery system includes n cell groups connected in series to form a battery pack. Each cell group includes at least one battery cell. The system also includes charge balancing circuitry having at least n−1 operational amplifiers each configured as a voltage follower. n is at least 3. And, a m^{th} operational amplifier of the n−1 operational amplifiers is powered by an aggregate voltage of corresponding m^{th} and (m+1)^{th} cells of the n cell groups that are connected in series.

A vehicle having a traction battery power source includes n power cells each having a positive and negative terminal and connected in series to form a power pack, and n−1 comparators configured as voltage followers. A negative terminal of a m^{th} comparator of the n−1 comparators is connected to the negative terminal of a corresponding m^{th} cell of the n cells, and a positive terminal of the m^{th} comparator is connected to the positive terminal of the (m+1)^{th} cell of the n cells.

A power storage system includes n cell groups connected in series to form a power pack. Each of the cell groups includes at least one power cell. The system also includes charge balancing circuitry having at least n−1 operational amplifiers each configured as a voltage follower. n is at least 3. And, a m^{th} operational amplifier of the at least n−1 operational amplifiers is powered by an aggregate voltage of corresponding m^{th} and (m+1)^{th} cell groups of the n cells groups connected in series.

### BRIEF DESCRIPTION OF THE DRAWINGS

FIG. 1 is an exemplary diagram of a hybrid vehicle illustrating typical drivetrain and energy storage components.

FIG. 2 is an exemplary diagram of a battery pack controlled by a Battery Energy Control Module.

FIG. 3 is an exemplary schematic diagram illustrating a charge balancing circuit.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The embodiments of the present disclosure generally provide for a plurality of circuits or other electrical devices. All references to the circuits and other electrical devices and the functionality provided by each, are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any one or more of the electric devices may be configured to execute a computer-program that is embodied in a non-transitory computer readable medium that is programmed to perform any number of the functions as disclosed.

Power packs such as battery packs are typically made of multiple cells connected in parallel to form a cell group and multiple cell groups connected in series to form the battery pack. Battery packs are often used as a source of power for common electronic devices including electrified vehicles, consumer electronics, industrial devices, and medical devices. Multiple cell groups connected in series allow use of a low voltage power cell to be used to power a high voltage power pack. As an example, a battery pack designed to produce approximately 300 volts at the battery terminals may comprise 84 cell groups each cell group connected in series to form a string of cell groups. Each cell group may comprise 3 individual cells connected in parallel; the individual cells may have a nominal cell voltage of approximately 3.5-3.6 Volts. In this example, any small change in individual battery cell voltage is multiplied by the number of cells in series, namely 84 in this example. Variations in production tolerances or operating conditions may produce a small difference between individual cells or cell groups that may be magnified with each charge or discharge cycle. To optimize battery operation, the use of cell balancing to equalize the charge on all of the cells in the series chain may be used to extend the battery life. Typically, battery cell balancing systems comprise electrical components including metal oxide semiconductor field effect transistors (MOSFETs), bipolar junction transistors (BJTs), diodes, capacitors, resistors, and other solid state devices. The electrical components of the cell balancing system typically are designed to operate at voltages that are a fraction of the battery pack voltage. To prevent a voltage greater than a component's maximum rating from being applied, some cell balancing components are isolated from the battery pack voltages. Further, many active cell balancing systems utilize a controller coupled with multiple cell balancing components in which the cell balancing components are isolated from the controller. The isolation components add cost and complexity. Here, a cell balancing system is shown without isolation components. This system is based on a cell balancing system in which each cell balancing element associated with a cell group operates autonomously and draws power from adjacent cell groups. The cell may be a battery cell, battery cell group, capacitor, super capacitor, or other power storage devices. The cell typically includes a positive terminal and a negative terminal. The terminals are connected either directly or indirectly with electrodes such as an anode and/or a cathode. The electrodes may be constructed of a metal based material such as Lithium or Nickel or a carbon based material such as graphite or graphene.

Charge equalization is important to both a state of charge of a power pack and a operational lifetime of the power pack. As stated above, often many low voltage cells or group of cells are connected either directly or indirectly in series to produce a power pack terminal voltage. A characteristic of this configuration is that all current for the power pack during both charging and discharging passes through each of the cells or group of cells. However, often one or more cells may have a cell voltage that differs because of history, manufacturing tolerances, or environmental conditions. As a cell discharges, that cell raises a pack resistance that is applied to a charger coupled with the pack. The increase in resistance reduces the power provided to each cell typically resulting in the other cells not being fully charged, or decreasing a rate of charge for the other cells. If the charging system is configured to and capable of raising the overall charging voltage to compensate for the resistance, the weaker cell will begin to heat up and further deteriorate. A weaker cell will contain less charge, and other cells will compensate for the lower charge.

Essentially, each battery cell acts as an integrator. Small changes in capacity of any one cell of the system may cause an increase in changes in how the system operates. If a few cells or cell groups of the pack have lower voltages, current may drain from a few batteries. Battery life is a strong function of charging/discharging history, and better cell voltage regulation enhances system life. One solution is charging in parallel and discharging in series. In large power systems such as an electric car or a hybrid vehicle, maintaining uniform charge in individual battery cells or battery cell groups is desired. In smaller, lower cost equipment, for example a camera, cell phone or power tool, the cost of a normal charge equalization circuit is prohibitively expensive.

The two main methods to balance battery cell charge in a group of battery cells are passive balancing and active balancing. Passive balancing is reducing a state of charge of a battery cell by converting the energy to thermal energy or heat. Here, a slight overcharge of a battery cell increases a temperature of the battery cell and the excess charge is released as thermal energy via an external circuit connected in parallel to each cell. The external circuit is typically a resistor and may include a solid state switch such as a MOSFET or BJT to connect and disconnect the resistor from the battery cell. Passive cell balancing may be used on many batteries technologies and topologies. Passive balancing is typically used in lead-acid and nickel-based batteries.

Active balancing is the active movement of an electric charge from one cell to another cell. Active balancing is applicable for most battery technologies and topologies. Active cell balancing may transfer energy from one individual cell to the battery pack as a whole, from the battery pack as a whole to one individual cell, or from one individual cell to a different individual cell. Generally, energy is transferred from a cell with a high state of charge to a cell with a low state of charge. Likewise, electric charge may be transferred to battery cells that have a low state of charge.

This disclosure, among other things, proposes a cell balancing system in which each cell balancing element associated with a cell group operates autonomously and draws power from adjacent cell groups. This cell balancing system may be configured for use in automobiles including battery electric vehicles (BEVs), hybrid electric vehicles (HEVs), microhybrid electric vehicles, conventional gasoline vehicles, and conventional diesel vehicles along with commercial, marine, and industrial. The battery system may also be used in other systems that include batteries such as consumer electric systems or medical electric systems. A voltage of an individual battery cell varies based on the technology. Generally Nickel based batteries have a cell voltage of approximately 1-2 volts (such as a nickel metal hydride battery cell) while a Lithium ion battery cell has a cell voltage of approximately 3-5 volts. For example, LiCoO₂ typically has a nominal cell voltage of 3.7 V with a gravimetric capacity of 140 mA·h/g and an energy density of 0.518 kW·h/kg. LiMn₂O₄ typically has a nominal cell voltage of 4.0 V with a gravimetric capacity of 100 mA·h/g and an energy density of 0.400 kW·h/kg. LiNiO₂ typically has a nominal cell voltage of 3.5 V with a gravimetric capacity of 180 mA·h/g and an energy density of 0.630 kW·h/kg. LiFePO₄ typically has a nominal cell voltage of 3.3 V with a gravimetric capacity of 150 mA·h/g and an energy density of 0.495 kW·h/kg. Li₂FePO₄F typically has a nominal cell voltage of 3.6 V with a gravimetric capacity of 115 mA·h/g and an energy density of 0.414 kW·h/kg. LiCo_{1/3}Ni_{1/3}Mn_{1/3}O₂ typically has a nominal cell voltage of 3.6 V with a gravimetric capacity of 160 mA·h/g and an energy density of 0.576 kW·h/kg. Li(LiₐNiₓMn_{y}Co_{z})O₂ typically has a nominal cell voltage of 4.2 V with a gravimetric capacity of 220 mA·h/g and an energy density of 0.920 kW·h/kg.

An aspect of this charge balancing circuitry is that, in one embodiment, each op-amp is associated with 2 cell groups or cells resulting in a system of n cells or cell groups requiring n−1 op-amps. Also, each op-amp is powered by 2 adjacent cells or cell groups. In another embodiment, each op-amp is associated with 4 cell groups or cells resulting in a system of n cells or cell groups requiring ((n/2)−1) op-amps in which each op-amp is powered by 4 adjacent cells or cell groups.

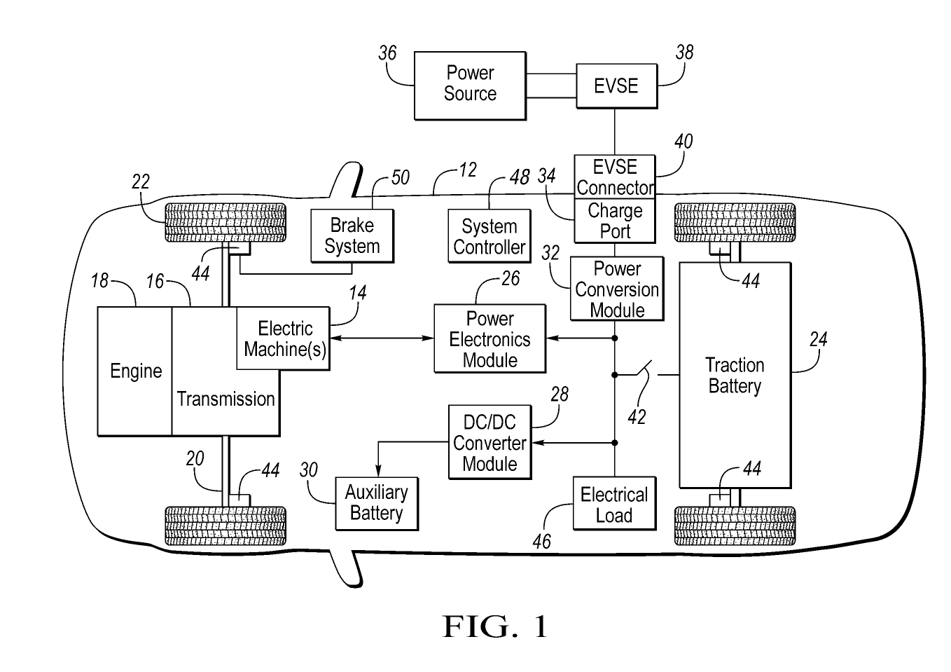

FIG. 1 depicts a typical plug-in hybrid-electric vehicle (PHEV) having a powertrain or powerplant that includes the main components that generate power and deliver power to the road surface for propulsion. A typical plug-in hybrid-electric vehicle 12 may comprise one or more electric machines 14 mechanically connected to a hybrid transmission 16. The electric machines 14 may be capable of operating as a motor or a generator. In addition, the hybrid transmission 16 is mechanically connected to an internal combustion engine 18 also referred to as an ICE or engine. The hybrid transmission 16 is also mechanically connected to a drive shaft 20 that is mechanically connected to the wheels 22. The electric machines 14 can provide propulsion and deceleration capability when the engine 18 is turned on or off. The electric machines 14 also act as generators and can provide fuel economy benefits by recovering energy that would normally be lost as heat in the friction braking system. The electric machines 14 may also reduce vehicle emissions by allowing the engine 18 to operate at more efficient speeds and allowing the hybrid-electric vehicle 12 to be operated in electric mode with the engine 18 off under certain conditions. A powertrain has losses that may include transmission losses, engine losses, electric conversion losses, electric machine losses, electrical component losses and road losses. These losses may be attributed to multiple aspects including fluid viscosity, electrical impedance, vehicle rolling resistance, ambient temperature, temperature of a component, and duration of operation.

A traction battery or battery pack 24 stores energy that can be used by the electric machines 14. A vehicle battery pack 24 typically provides a high voltage DC output. The traction battery 24 is electrically connected to one or more power electronics modules 26. One or more contactors 42 may isolate the traction battery 24 from other components when opened and connect the traction battery 24 to other components when closed. The power electronics module 26 is also electrically connected to the electric machines 14 and provides the ability to bi-directionally transfer energy between the traction battery 24 and the electric machines 14. For example, a typical traction battery 24 may provide a DC voltage while the electric machines 14 may operate using a three-phase AC current. The power electronics module 26 may convert the DC voltage to a three-phase AC current for use by the electric machines 14. In a regenerative mode, the power electronics module 26 may convert the three-phase AC current from the electric machines 14 acting as generators to the DC voltage compatible with the traction battery 24. The description herein is equally applicable to a pure electric vehicle. For a pure electric vehicle, the hybrid transmission 16 may be a gear box connected to an electric machine 14 and the engine 18 may not be present.

In addition to providing energy for propulsion, the traction battery 24 may provide energy for other vehicle electrical systems. A typical system may include a DC/DC converter module 28 that converts the high voltage DC output of the traction battery 24 to a low voltage DC supply that is compatible with other vehicle loads. Other high-voltage loads 46, such as compressors and electric heaters, may be connected directly to the high-voltage without the use of a DC/DC converter module 28. The low-voltage systems may be electrically connected to an auxiliary battery 30 (e.g., 12V battery).

The vehicle 12 may be an electric vehicle or a plug-in hybrid vehicle in which the traction battery 24 may be recharged by an external power source 36. The external power source 36 may be a connection to an electrical outlet that receives utility power. The external power source 36 may be electrically connected to electric vehicle supply equipment (EVSE) 38. The EVSE 38 may provide circuitry and controls to regulate and manage the transfer of energy between the power source 36 and the vehicle 12. The external power source 36 may provide DC or AC electric power to the EVSE 38. The EVSE 38 may have a charge connector 40 for plugging into a charge port 34 of the vehicle 12. The charge port 34 may be any type of port configured to transfer power from the EVSE 38 to the vehicle 12. The charge port 34 may be electrically connected to a charger or on-board power conversion module 32. The power conversion module 32 may condition the power supplied from the EVSE 38 to provide the proper voltage and current levels to the traction battery 24. The power conversion module 32 may interface with the EVSE 38 to coordinate the delivery of power to the vehicle 12. The EVSE connector 40 may have pins that mate with corresponding recesses of the charge port 34. Alternatively, various components described as being electrically connected may transfer power using a wireless inductive coupling.

One or more wheel brakes 44 may be provided for decelerating the vehicle 12 and preventing motion of the vehicle 12. The wheel brakes 44 may be hydraulically actuated, electrically actuated, or some combination thereof. The wheel brakes 44 may be a part of a brake system 50. The brake system 50 may include other components to operate the wheel brakes 44. For simplicity, the figure depicts a single connection between the brake system 50 and one of the wheel brakes 44. A connection between the brake system 50 and the other wheel brakes 44 is implied. The brake system 50 may include a controller to monitor and coordinate the brake system 50. The brake system 50 may monitor the brake components and control the wheel brakes 44 for vehicle deceleration. The brake system 50 may respond to driver commands and may also operate autonomously to implement features such as stability control. The controller of the brake system 50 may implement a method of applying a requested brake force when requested by another controller or sub-function.

One or more electrical loads 46 or auxiliary electric loads may be connected to the high-voltage bus. The electrical loads 46 may have an associated controller that operates and controls the electrical loads 46 when appropriate. Examples of auxiliary electric loads or electrical loads 46 include a battery cooling fan, an electric air conditioning unit, a battery chiller, an electric heater, a cooling pump, a cooling fan, a window defrosting unit, an electric power steering system, an AC power inverter, and an internal combustion engine water pump.

The various components discussed may have one or more associated controllers to control and monitor the operation of the components. The controllers may communicate via a serial bus (e.g., Controller Area Network (CAN), Ethernet, Flexray) or via discrete conductors. A system controller 48 may be present to coordinate the operation of the various components.

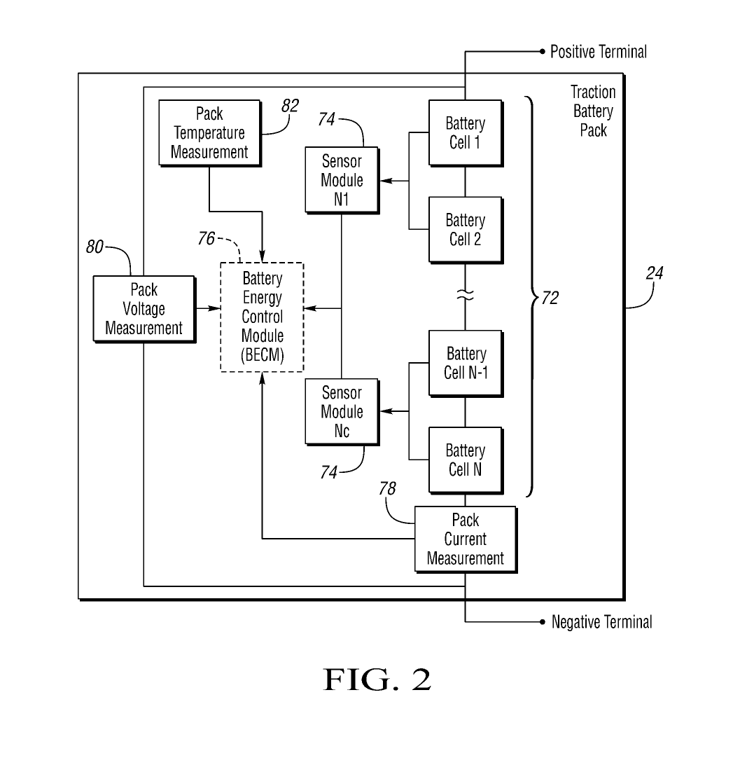

A traction battery 24 may be constructed from a variety of chemical formulations. Typical battery pack chemistries may be lead acid, nickel-metal hydride (NIMH) or Lithium-Ion. FIG. 2 shows a typical traction battery pack 24 in a series configuration of N battery cells 72. Other battery packs 24, however, may be composed of any number of individual battery cells connected in series or parallel or some combination thereof. A battery management system may have one or more controllers, such as a Battery Energy Control Module (BECM) 76 that monitors and controls the performance of the traction battery 24. The BECM 76 may include sensors and circuitry to monitor several battery pack level characteristics such as pack current 78, pack voltage 80 and pack temperature 82. The BECM 76 may have non-volatile memory such that data may be retained when the BECM 76 is in an off condition. Retained data may be available upon the next key cycle.

In addition to the pack level characteristics, there may be battery cell level characteristics that are measured and monitored. For example, the terminal voltage, current, and temperature of each cell 72 may be measured. The battery management system may use a sensor module 74 to measure the battery cell characteristics. Depending on the capabilities, the sensor module 74 may include sensors and circuitry to measure the characteristics of one or multiple of the battery cells 72. The battery management system may utilize up to N_{c} sensor modules 74 such as a Battery Monitor Integrated Circuits (BMIC) module to measure the characteristics of all the battery cells 72. Each sensor module 74 may transfer the measurements to the BECM 76 for further processing and coordination. The sensor module 74 may transfer signals in analog or digital form to the BECM 76. In some embodiments, the sensor module 74 functionality may be incorporated internally to the BECM 76. That is, the sensor module hardware may be integrated as part of the circuitry in the BECM 76 and the BECM 76 may handle the processing of raw signals.

The BECM 76 may include circuitry to interface with the one or more contactors 42. The positive and negative terminals of the traction battery 24 may be protected by contactors 42.

Battery pack state of charge (SOC) gives an indication of how much charge remains in the battery cells 72 or the battery pack 24. The battery pack SOC may be output to inform the driver of how much charge remains in the battery pack 24, similar to a fuel gauge. The battery pack SOC may also be used to control the operation of an electric or hybrid-electric vehicle 12. Calculation of battery pack SOC can be accomplished by a variety of methods. One possible method of calculating battery SOC is to perform an integration of the battery pack current over time. This is well-known in the art as ampere-hour integration.

Battery SOC may also be derived from a model-based estimation. The model-based estimation may utilize cell voltage measurements, the pack current measurement, and the cell and pack temperature measurements to provide the SOC estimate.

The BECM 76 may have power available at all times. The BECM 76 may include a wake-up timer so that a wake-up may be scheduled at any time. The wake-up timer may wake up the BECM 76 so that predetermined functions may be executed. The BECM 76 may include non-volatile memory so that data may be stored when the BECM 76 is powered off or loses power. The non-volatile memory may include Electrical Eraseable Programmable Read Only Memory (EEPROM) or Non-Volatile Random Access Memory (NVRAM). The non-volatile memory may include FLASH memory of a microcontroller.

When operating the vehicle, actively modifying the way battery SOC is managed can yield higher fuel economy or longer EV-mode (electric propulsion) operation, or both. The vehicle controller must conduct these modifications at both high SOC and low SOC. At low SOC, the controller can examine recent operating data and decide to increase SOC via opportunistic engine-charging (opportunistic means to do this if the engine is already running). This is done to provide longer EV-mode operation when the engine turns off. Conversely, at high SOC, the controller can examine recent operating data and other data (location, temperature, etc.) to reduce SOC via EV-mode propulsion, reduced engine output, or auxiliary electrical loads. This is done to provide higher battery capacity to maximize energy capture during an anticipated regenerative braking event, such as a high-speed deceleration or hill descent.

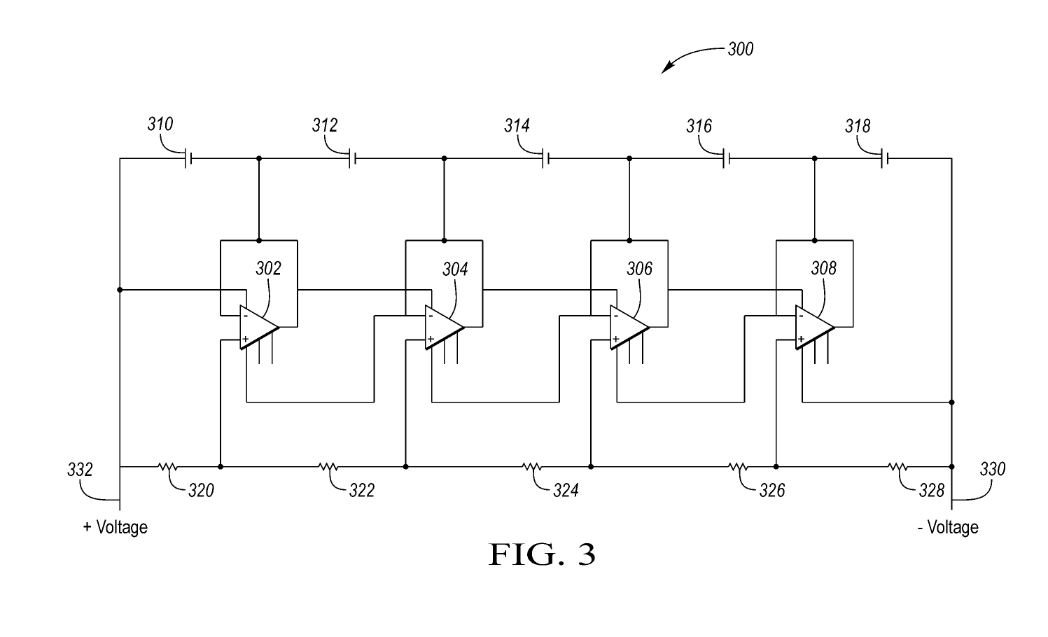

FIG. 3 is an exemplary schematic diagram illustrating a charge balancing circuit 300. An aspect of this circuit is that battery cells are essentially non-linear integrators. Regulation of integrators may be accomplished with op-amps, comparators, differential input operational amplifiers, or equivalent circuits. In FIG. 3, a 5 series cell diagram is shown. Cells (310, 312, 314, 316, and 318) are connected in series by the normal charging/discharging circuitry. This illustration is of individual battery cells (310, 312, 314, 316, and 318), however it may be battery cell groups, super capacitors, or other power storage devices. For example, cell 310 may be a single battery cell or multiple battery cells connected in parallel. The connection may be a direct or indirect connection.

A voltage divider is shown connected to battery terminals 330 and 332 in parallel with the cells (310, 312, 314, 316, and 318). The voltage divider may be resistors, solid state devices, semiconductors, or other similar structure. In this illustration, resistors (320, 322, 324, 326, and 328) are shown connected in parallel to the normal charging/discharging circuitry. For example, the resistors may be 100 K-ohm resistors. Operational amplifiers (302, 304, 306, and 308) (op-amps) are connected between the cells (310, 312, 314, 316, and 318) such that each op-amp regulates the voltage between adjacent cells based on how well the adjacent cells are integrating. For example, if during charging, cell 312 has a large resistance, instead of cell 312 receiving a greater proportion of the voltage, as would be the case in a simple series connected circuit; cell 312 would receive less voltage as op-amps 302 and 304 regulate the voltage at each terminal of cell 312. If a temperature of one cell changes or some other event occurs to change the voltage of the one cell, another cell may begin to receive a lower voltage and the lower voltage to the other cell may increase. Similarly, during discharge, if one cell is not able to output an equal share of voltage with respect to other cells, the other cells may be able to make up the difference. The output is regulated on a cell-wise basis.

Electrical and operational characteristics of the op-amp varies based on the application, along with electrical characterizes of each cell including current voltage, operating voltage range, cell technology, and capacity. For example, small portable devices that may be powered on indefinitely may have more strict operating leakage current requirements as even a few milliamps can make a difference. Likewise, a large battery pack capable of handling large currents (e.g., over 100 Amps) may require larger op-amps to transfer appropriate currents required during operation. As the voltage across each cell actually powers the op-amp, cells, or combinations of cells, very small voltage can be accommodated. Likewise, for cell technology in which an op-amp requires a larger voltage than 2 adjacent cells, the circuit may be modified such that each cell (310, 312, 314, 316, or 318) may be multiple cells connected in series or a combination of series and parallel. The ratio of resistors (320, 322, 324, 326, and 328) determines how accurately the voltage will be controlled; precision resistors may be required or the use of a precision voltage divider. In addition, ratios of voltage dividers such as resistors (320, 322, 324, 326, and 328) may be used to compensate for custom or mixed cell usage. For example, a power pack may include 4 cells each having a cell voltage of 1.2V and a single cell may be connected in series having a cell voltage of 3.6V, the voltage divides may be chosen to accommodate the power pack design.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A battery system comprising:
n cell groups connected in series to form a battery pack, wherein each cell group includes at least one battery cell; and
charge balancing circuitry including at least n−1 operational amplifiers each configured as a voltage follower, wherein n is at least 3 and wherein a m^{th} operational amplifier of the n−1 operational amplifiers is powered by an aggregate voltage of corresponding m^{th} and (m+1)^{th} cells of the n cell groups that are connected in series.

2. The system of claim 1 further comprising at least n resistors connected together in series to form a string of resistors and wherein the string of resistors is connected in parallel with the battery pack to produce a reference voltage for each of the n cell groups.

3. The system of claim 1, wherein the operational amplifiers include Schmitt trigger inputs.

4. The system of claim 1, wherein the operational amplifiers are differential input operational amplifiers.

5. The system of claim 1, wherein the operational amplifiers are configured as inverting circuits based on a positive terminal of the m^{th} cell.

6. The system of claim 5, wherein the operational amplifiers are configured as non-inverting circuits based on a reference voltage associated with the positive terminal of the m^{th} cell.

7. A vehicle having a traction battery power source comprising:
n power cells each having a positive and negative terminal and connected in series to form a power pack; and
n−1 comparators configured as voltage followers, wherein a negative terminal of a m^{th} comparator of the n−1 comparators is connected to the negative terminal of a corresponding m^{th} cell of the n cells, and a positive terminal of the m^{th} comparator is connected to the positive terminal of a (m+1)^{th} cell of the n cells.

8. The vehicle of claim 7, further comprising at least n resistors connected together in series to form a string of resistors and wherein the string of resistors is connected in parallel with the power pack to produce a reference voltage for each cell.

9. The vehicle of claim 8, wherein the comparators are configured as an inverting circuit based on a positive terminal of the m^{th} cell.

10. The vehicle of claim 9, wherein the comparators are configured as a non-inverting circuit based on the reference voltage associated with the positive terminal of the m^{th} cell.

11. The vehicle of claim 7, wherein the comparators are operational amplifiers.

12. The vehicle of claim 7, wherein at least one of the power cells is a super capacitor cell.

13. The vehicle of claim 7, wherein at least one of the power cells is a rechargeable battery cell.

14. A power storage system comprising:
n cell groups connected in series to form a power pack, wherein each of the cell groups includes at least one power cell; and
charge balancing circuitry including at least n−1 operational amplifiers each configured as a voltage follower, wherein n is at least 3 and wherein a m^{th} operational amplifier of the at least n−1 operational amplifiers is powered by an aggregate voltage of corresponding m^{th} and (m+1)^{th} cell groups of the n cells groups connected in series.

15. The system of claim 14, wherein the at least one power cell is a rechargeable battery cell.

16. The system of claim 15, wherein the battery cell is a Lithium Ion battery cell.

17. The system of claim 15, wherein the battery cell is at least two Nickel Metal Hydride battery cells.

18. The system of claim 14, wherein the at least one power cell is a super capacitor cell.

19. The system of claim 14, wherein the at least one power cell includes an electrode containing Carbon.

20. The system of claim 14, further comprising at least n resistors connected together in series to form a string of resistors and wherein the string of resistors is connected in parallel with the power pack to produce a reference voltage for each cell.
